(19) United States
(12) Patent Application Publication
(10) Pub. No.: US 2009/0009900 A1
(43) Pub. Date: Jan. 8, 2009

(54) Color filter, optical sensor mounted with color filter, and method for manufacturing same

(75) Inventors: Koji Yagi, Ibi-gun (JP); Hiroshi Ohshima, Ogaki-shi (JP)

Correspondence Address: OLIFF & BERRIDGE, PLC, P.O. BOX 320850, ALEXANDRIA, VA, 22320-4850, US

(73) Assignees: SANYO ELECTRIC CO., LTD., MORIGUCHI-SHI (JP); SANYO SEMICONDUCTOR CO., LTD., ORA-GUN (JP)

(21) Appl. No.: 12/216,416

(22) Filed: Jul. 3, 2008

(30) Foreign Application Priority Data
Jul. 5, 2007 (JP) 2007-177641

(51) Int. Cl. G02B 5/20; G01J 1/04

(52) U.S. Cl. 359/891; 250/226

(57) ABSTRACT

A color filter is manufactured on each of a plurality of light-receiving elements of an RGB sensor using a plurality of kinds of light-transmitting films having different transmission colors. In such a case, the light-transmitting film that is to be coated next does not uniformly spread across the entire semiconductor wafer, and coating nonuniformities readily occur when a pattern of the light-transmitting film formed earlier on a certain optical element has a right angle portion. In order to solve this problem, the pattern of the light-transmitting film formed earlier has a planar shape having corner-cut portions so that right angle portions do not occur.

### CROSS-REFERENCE TO RELATED APPLICATION

The priority application number JP2007-177641 upon which this patent application is based is hereby incorporated by reference.

### BACKGROUND OF THE INVENTION

1. Field of the Invention

The present invention relates to a color filter, an optical sensor mounted with the color filter, and a method for manufacturing the same, and particularly relates to a color filter in an RGB sensor.

2. Description of the Related Art

In recent years, there have been cases in which optical sensors such as RGB sensors are mounted in mobile phones, liquid crystal display devices, and the like in order to adjust the intensity of the backlight. An RGB sensor is a sensor that can divide and detect visible light having a wavelength within the range of 380 nm to 780 nm into three color signals corresponding to red (R), green (G), and blue (B). The RGB sensor has a configuration in which a visible light sensor and a light-transmitting film that selectively transmits each RGB color are combined. Three photodiodes corresponding to the number of colors to be detected are provided as the visible light sensor. Any one of the light-transmitting films of the RGB is disposed on the light receiving surface of each photodiode. The essential characteristics of the visible light sensor are the same as that of the photodiode, and the characteristics of each photodiode are essentially shared characteristics.

A cross-sectional view (the upper portion of FIG. 9) and a plan view (the lower portion of FIG. 9) of a conventional RGB sensor 100 are shown in FIG. 9. A plurality of optical elements 104 composed of a photodiode is formed corresponding to each RGB color near the surface of a semiconductor substrate 102 wherein the planar shape is rectangular. For example, an optical element 104 composed of a PN junction formed by adding an N-type impurity to an area in the vicinity of the surface of the substrate can be used when the semiconductor substrate 102 is a P-type semiconductor substrate. In this case, light is converted into electric energy by photoelectric conversion effect when the light is incident on the area where the N-type impurity has been added. The area of the N-type impurity is particularly referred to as a light-receiving portion.

Light-transmitting films 106, 108, 110 that selectively transmit each RGB color are formed on the semiconductor substrate 102 on which the optical elements 104 and the like are formed, and a RGB color filter is formed. The light-transmitting films 106, 108, 110 are disposed on mutually different optical elements 104. For example, the light-transmitting films 106, 108, and 110 are formed using a substance that transmits only the light of wavelength ranges that correspond to “R”, “G”, and “B”, respectively. A photosensitive resin material that has been colored by a pigment can be used as the material of the light-transmitting films 106, 108, 110.

Each of the light-transmitting films 106, 108, 110 is formed so that the boundary between adjacent films is disposed on an isolation region 112. The light-transmitting films 106, 108, 110 are thereby selectively formed for each optical element 104 as described above.

Next, the method for manufacturing a color filter in the conventional RGB sensor 100 will be described. The manufacture of a color filter is performed in a state in which the semiconductor wafer 102 has a plurality of RGB sensors 100 formed thereon, as shown in FIG. 10. The RGB sensors 100 are cut apart from the semiconductor wafer 102 by dicing, after the color filter has been formed. Furthermore, the final product in which the RGB sensors 100 are mounted is completed by a CSP (Chip size package) technique or another packaging technique.

First, the steps for forming the light-transmitting film 106 on the area corresponding to “R” of each of the RGB sensors 100 in the semiconductor wafer 102 will be described. A photosensitive resin material containing a red-colored pigment is coated using spin coating or another method across the entire surface of the semiconductor wafer 102 (semiconductor substrate 102). The light-transmitting film 106 corresponding to “R” is thereafter formed on each of the RGB sensors 100 in the rectangular shape shown in the plan view of FIG. 9 by exposing the photosensitive resin material using a photomask and performing a development process. Next, the light-transmitting film 108 corresponding to “G” is formed on the area corresponding to “G”. The light-transmitting film 108 corresponding to “G” is also formed by the same method as in the case of “R”. Lastly, the light-transmitting film 110 corresponding to “B” is formed on the area corresponding to “B” using the same method.

The rectangular semiconductor substrate 102 constituting the RGB sensor 100 is partitioned into three aligned rectangular areas that correspond to one of each of three colors R, G, and B. The light-transmitting films 106, 108, 110 that constitute the color filter of a conventional RGB sensor 100 are formed in a rectangular shape by the manufacturing process described above in which the three rectangular areas of the semiconductor substrate 102 are matched.

Japanese Laid-open Patent Application No. 2006-163316 is an example of a technical document related to the formation of the color filter described above.

The conventional color filter formation technique described above has a problem in that the photosensitive resin material does not uniformly spread across the entire semiconductor wafer, and coating nonuniformities occur during coating of the photosensitive resin material of the second color and thereafter in cases in which the pattern of the light-transmitting film of the first color (“R”) is a rectangle, i.e., in cases in which the light-transmitting film has a right angle portion, in the step for forming a light-transmitting film of the colors (“G”, “B”) of the second color and thereafter. Specifically, when the photosensitive resin material 112 is fed dropwise in the vicinity of the center of the semiconductor wafer 102 and the semiconductor wafer is coated over the entire surface by spin-coating, as shown in FIG. 11, it is difficult for the photosensitive resin material 112 to pass over the light-transmitting film of the first color and spread out because the photosensitive resin material 112 is divided into two parts at the right angle portion and easily spreads along the side wall of the light-transmitting film of the first color when the light-transmitting film of the first color has a right angle portion. As a result, it is difficult to uniformly coat the photosensitive resin material 112 in the area where the light-transmitting film of the second color will be formed.

### SUMMARY OF THE INVENTION

The present invention, in order to solve the problems described above, provides a color filter composed of a plurality of kinds of light-transmitting films formed on a substrate and provided with different transmission colors, the plurality of kinds of light-transmitting films being selectively disposed on each of a plurality of optical elements provided to the substrate, wherein the light-transmitting films disposed on the optical elements have a planar shape in which corner-cut portions are formed so that right angle portions are removed.

An isolation region is formed between adjacent optical elements, and the corner-cut portions are superimposed and formed on the isolation region.

### BRIEF DESCRIPTION OF THE DRAWINGS

FIGS. 1 to 6 are schematic cross-sectional and plan views showing each step of the method for manufacturing a color filter according to an embodiment of the present invention;

FIG. 7 is a schematic plan view of a color filter according to another embodiment of the present invention;

FIG. 8 is a schematic plan view of a color filter according to yet another embodiment of the present invention;

FIG. 9 is a schematic cross-sectional and plan view of a conventional color filter;

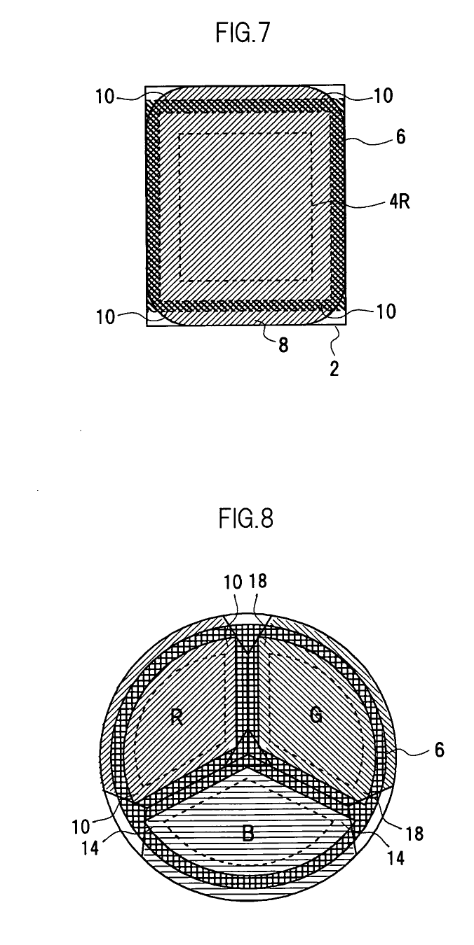

FIG. 10 is a schematic plan view of a RGB sensor disposed on a semiconductor wafer; and

FIG. 11 is a schematic plan view showing the steps of a method for manufacturing a color filter according to a conventional optical sensor.

### DESCRIPTION OF THE PREFERRED EMBODIMENTS

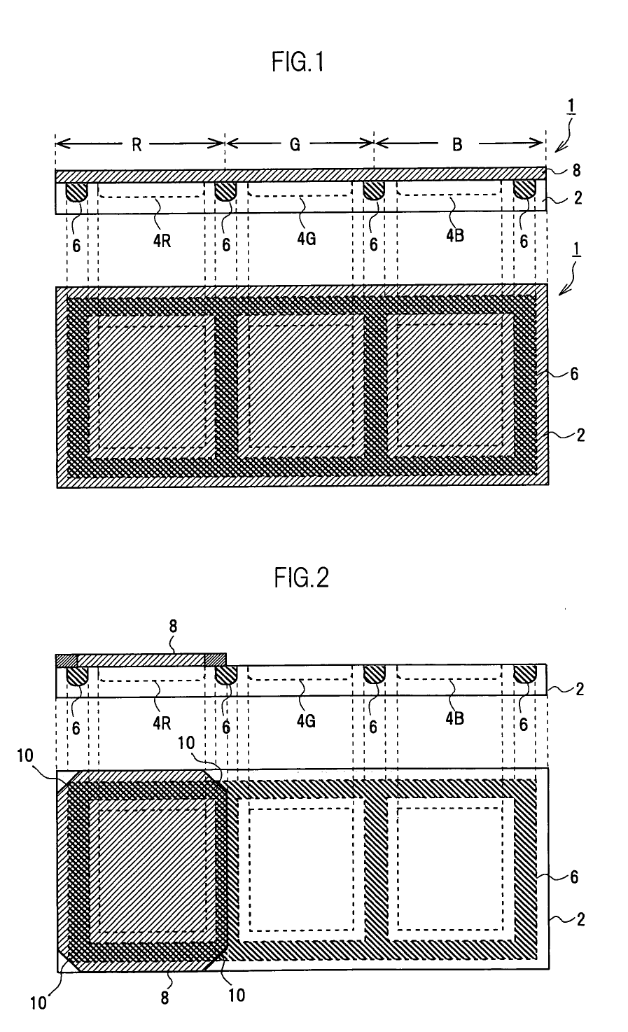

The method for manufacturing a color filter in an embodiment of the present invention is described in detail with reference to FIGS. 1 to 6. In the present embodiment, the method for manufacturing a color filter in an RGB sensor 1 will be described in particular. FIGS. 1 to 6 are each schematic cross-sectional and plan views showing the structure of the RGB sensor 1 in which the method for manufacturing the color filter of the present invention is applied. The cross-sectional view of the RGB sensor 1 is shown in the upper portions of each of the FIGS. 1 to 6, and the plan view of RGB sensor 1 is shown in the lower portion, with the positions in the horizontal direction associated with the cross-sectional view thereabove. In the present embodiment, the manufacturing method in which the color filter is formed in the sequence of “R”, “G”, and “B” will be described, but the present invention is not limited to this sequence.

FIG. 1 shows the steps for forming an “R” color filter. Three rectangular optical elements 4 are formed in a single row on a surface of a semiconductor substrate 2. The optical element 4 is configured in the same manner as a conventional optical element 104. An isolation region 6 is provided in order to electrically isolate the optical elements 4 from each other. The isolation region 6 is formed along a side of the optical elements 4, and is the same as a conventional configuration.

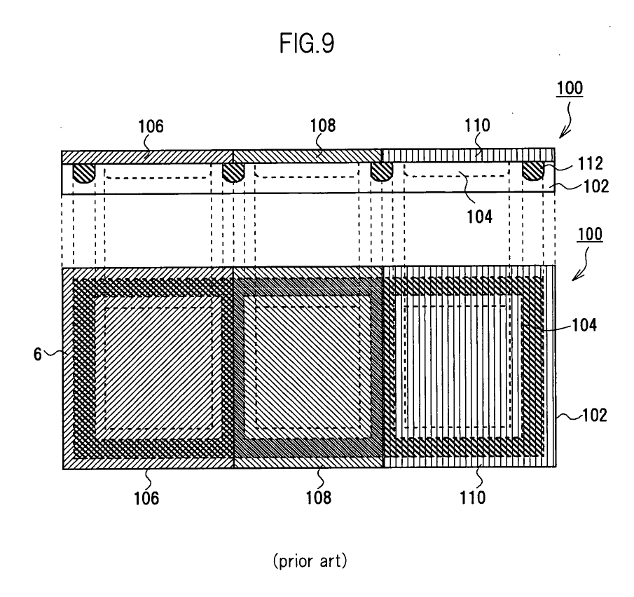

A light-transmitting film 8 is coated by spin coating or another method on the entire surface of the semiconductor substrate 2 on which the optical elements 4 are disposed. FIG. 1 shows only a single RGB sensor 1, but the manufacturing process of the color filter of the present invention is carried out for a plurality of RGB sensors 1 arrayed on the semiconductor wafer 102, as shown in FIG. 10, in the same manner as a conventional process for manufacturing a color filter. A photosensitive resin material that contains a red pigment is used in the light-transmitting film 8. An example in which a negative photosensitive resin material is used will be described below, but the present manufacturing method can be implemented in the same manner even when a positive photosensitive resin material is used by essentially inverting the transmitting area and the light-blocking area of a photomask.

The photomask (not shown) is disposed on the light-transmitting film 8, and the light-transmitting film 8 is exposed by light that passes through the photomask. Since a negative photosensitive resin material is used in the present example, a photomask is used which transmits light in the area where the color filter “R” is formed and which blocks the light in other areas. The photosensitive resin material is cured in the area where the light is radiated (the area where the light-transmitting film 8 of “R” is formed), and is not cured in other areas.

The light-transmitting film 8, which was blocked at the time of exposure and was not exposed, is then removed by etching using a developing fluid. As a result, a light-transmitting film 8 having the pattern shown in FIG. 2 is formed. The planar shape of the light-transmitting film 8 is essentially substantially rectangular in accordance with the shape of an optical element 4, but has corner-cut portions 10 in each of the four corners. Therefore, the exact shape of the light-transmitting film 8 is an octagon formed by removing the apex portion of the right angles from the rectangle. All corners in the light-transmitting film 8 that has been patterned are therefore an obtuse angle (greater than 90° and 180° or less).

The apex portions of the rectangle that are removed in order to form the corner-cut portions 10 are preferably set so as to not overlap the optical element 4. In other words, situations in which the optical element 4 is not covered by the light-transmitting film 8 and is exposed should be avoided. A color filter that corresponds to “R” is formed in the manner described above.

Next, the method for manufacturing a color filter that corresponds to “G” will be described with reference to FIGS. 3 to 4. The color filter that corresponds to “G” is produced by substantially the same manufacturing method as the color filter that corresponds to “R”.

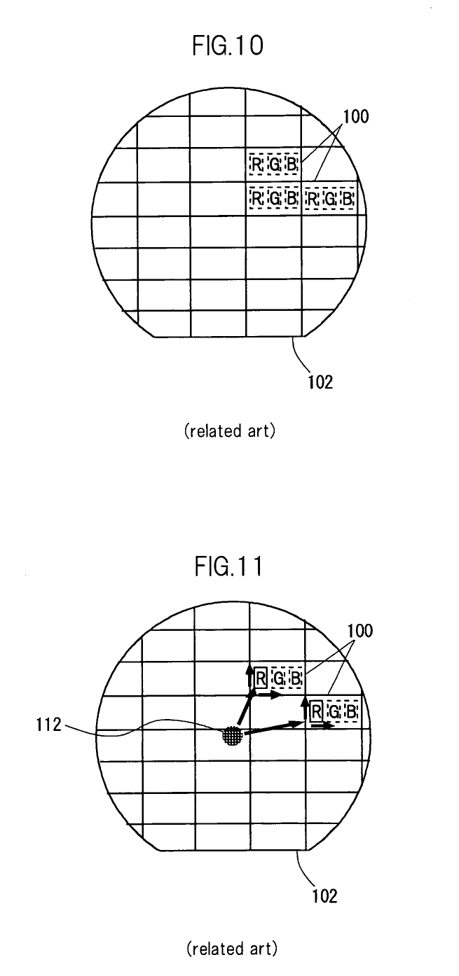

A photosensitive resin material (light-transmitting film 12) containing a green-colored pigment is coated using spin coating or another method across the entire surface of the semiconductor substrate 2 in which the light-transmitting film 8 of “R” is formed, as shown in FIG. 3. In the coating step of the light-transmitting film 12 of the second color (“G”), the light-transmitting film 12 cannot be uniformly coated across the entire surface of the semiconductor wafer 102 and the coating becomes nonuniform when the light-transmitting film 8 of the first color (“R”) does not have corner-cut portions 10, as in the prior art. This problem is particularly prominent when the color filter is thinly formed in accordance with demands related to the device characteristics of the RGB sensor. When the color filter is thinly formed, the photosensitive resin material can be fed dropwise only in small amounts, and it therefore becomes difficult for the photosensitive resin material to extend beyond the light-transmitting film already formed, as shown in FIG. 11. However, the photosensitive resin material can readily extend beyond the light-transmitting film already formed and to spread and uniformly coat the light-transmitting film 12 of the second color on the semiconductor wafer 102 or the RGB sensor 1 without the creation of coating nonuniformities. This is achieved by providing the corner-cut portions 10 to the light-transmitting film 8 of the first color, as in the present invention, even when the color filter is thinly formed.

The photomask, which is not shown, is disposed on the light-transmitting film 12, the light-transmitting film 12 is exposed to the light transmitted therethrough, and only the area of the light-transmitting film 12 that corresponds to “G” is selectively solidified. The light-transmitting film 12 in the areas that correspond to “R” and “B” and were blocked and not cured during exposure is removed by etching using a developing fluid in a development process. As a result, a light-transmitting film 12 having the pattern shown in FIG. 4 is formed. The light-transmitting film 12 has the same corner-cut portions 14 as the light-transmitting film 8 of “R”. The apex portions of a rectangle that are removed in order to form the corner-cut portions 14 of the light-transmitting film 12 do not overlap with the optical element 4, and are formed in a manner that exposes the isolation region 6 in the vicinity of the boundary of the optical element 4 of “R” and the optical element 4 of “G”. The side at which the light-transmitting film 8 corresponding to “R” and the light-transmitting film 12 corresponding to “G” are in contact is preferably formed on the isolation region 6.

The light-transmitting film 8 of “R” and the light-transmitting film 12 of “G” do not necessarily have to be in contact. For example, the light-transmitting film 12 may be superimposed and formed on the light-transmitting film 8. However, it is preferred that the boundary portion between the light-transmitting film 8 and the light-transmitting film 12 be set within the formation area of the isolation region 6. Specifically, when the light-transmitting film 8 and the light-transmitting film 12 are in contact, it is advantageous that the end of the tangent lines (two of the eight corners wherein the light-transmitting film 8 and the light-transmitting film 12 are in contact) be formed on the isolation region 6. When the light-transmitting film 8 and the light-transmitting film 12 are superimposed at the boundary portion, it is preferred that the intersection point in which one side of the light-transmitting film 8 and one side of the light-transmitting film 12 intersect each other be formed on the isolation region 6.

In the conventional method for manufacturing a color filter, each light-transmitting film is formed on an optical element without a gap. Therefore, the RGB sensor must be cut and the cross-section must be observed in order to detect defects in which each light-transmitting film is not formed in an appropriate position due to the mask being out of alignment when the light-transmitting film of “B” is, e.g., formed on an optical element where the light-transmitting film of “R” will be formed. In contrast, in the present invention, it can be easily visually confirmed whether or not a light-transmitting film is appropriately disposed on a corresponding optical element 4 by the corner-cut portions formed on each light-transmitting film. Specifically, the light-transmitting film transmits light in a specific wavelength band, and the isolation region 6 formed on the lower layer of the light-transmitting film can therefore be visually confirmed even from the upper surface of the RGB sensor 1. In view of the above, it can then be confirmed whether or not the end of the tangent line or the intersection of the light-transmitting film 8 of “R” and the light-transmitting film 12 of “G” is formed within the width of the isolation region 6 formed between the optical element 4R and the optical element 4G. The defect detection operation can thereby be performed easily and efficiently.

Next, the method for manufacturing a color filter that corresponds to “B” will be described with reference to FIGS. 5 and 6. The color filter that corresponds to “B” is manufactured using essentially the same method as the one used to manufacture the color filters that correspond to “R”, “G”.

A photosensitive resin material (light-transmitting film 16) containing a blue-colored pigment is coated by spin coating or another method across the entire surface of the semiconductor substrate 2 on which the light-transmitting films 8, 12 of “R” and “G” are formed, as shown in FIG. 5. A photomask, which is not shown, is disposed on the light-transmitting film 16, the light-transmitting film 16 is exposed to the light transmitted therethrough, and only the area of the light-transmitting film 16 that corresponds to “B” is selectively solidified. The light-transmitting film 16 of the areas that correspond to “R” and “G” and were blocked and not cured during exposure is removed by etching using a developing fluid in a development process. As a result, a light-transmitting film 16 having the pattern shown in FIG. 6 is formed. The light-transmitting film 16 has the same corner-cut portions 18 as the light-transmitting films 8, 12 of “R” and “G”.

A color filter in the RGB sensor 1 is formed in the manner described above. After the color filter has been formed, a protective film (not shown) may be formed across the entire surface of RGB sensor 1.

In the prior art, nonuniformity of the coating is dramatic when the color filter is thinly formed as described above. However, even when the color filter is thickly formed, nonuniformities may still be generated in a later-formed protective film due to the stepped nature of the light-transmitting films 8, 12, 16 if the corner-cut portions 10, 14, 18 on each light-transmitting film 8, 12, 16 are not present. Therefore, the protective film can be uniformly formed on the semiconductor wafer 102, even when the color filter is thickly formed, by providing the corner-cut portions 10, 14, 18 in the manner of the present invention.

The thickness of each of the light-transmitting films 8, 12, 16 of the RGB does not necessarily have to be the same. For example, there are cases in which the light-transmitting film 12 of “G” is formed more thinly than the light-transmitting films 8, 16 of “R” and “B”. Even in such a case, the protective film layered on each light-transmitting film can be uniformly coated because each of the light-transmitting films 8, 12, 16 has a corner cut portion 10, 14, 18.

A smoothed film may be formed on the semiconductor substrate 2 before the color filter is formed. The smoothed film is layered, whereby the light-transmitting films of a plurality of colors formed thereafter can be formed without difference in height, and the occurrence of coating nonuniformities can be prevented. A wiring layer composed of a metallic layer and an insulation layer is normally disposed on the semiconductor substrate 2. In this case, an opening section can be provided to the insulation film on the optical element 4 in order to control the reduction of the light incident on the optical element 4. It is advantageous to form the smoothed film on the wiring layer even in such a case.

The surface area of the light-transmitting films 8, 12, 16 of each RGB color may be varied in accordance with the demands of the device characteristics of the RGB sensor 1. In this case as well, the occurrence of coating nonuniformities in the coating of the light-transmitting film of the second color and thereafter can be prevented by providing the corner-cut portions 10, 14, 18 to each of the light-transmitting film 8, 12, 16.

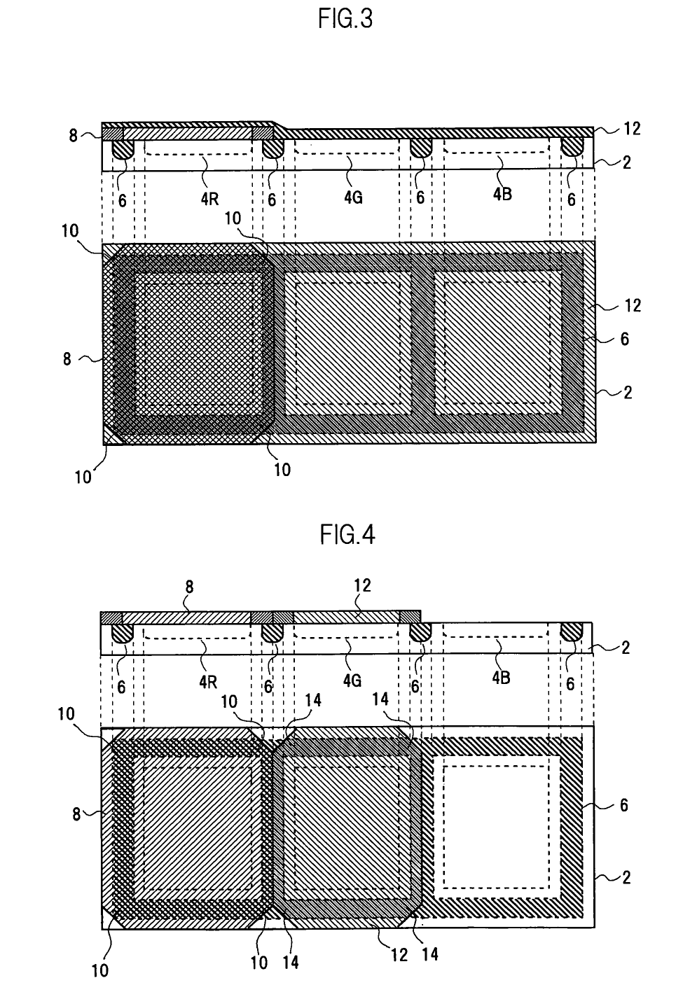

Next, another embodiment of the present invention will be described with reference to FIG. 7. Only the portion corresponding to “R” of the RGB sensor is shown in FIG. 7; however, the same applies to “G”, “B”. In the present embodiment, the corners of the light-transmitting film 8 have a curvilinearly cutaway shape. The light-transmitting films of the second color and thereafter can be more uniformly coated across the entire surface of the semiconductor wafer 102 in comparison with a shape still having corners even when the corners have been cut off, as shown in FIG. 6, by the light-transmitting film 8 being curvilinearly notched.

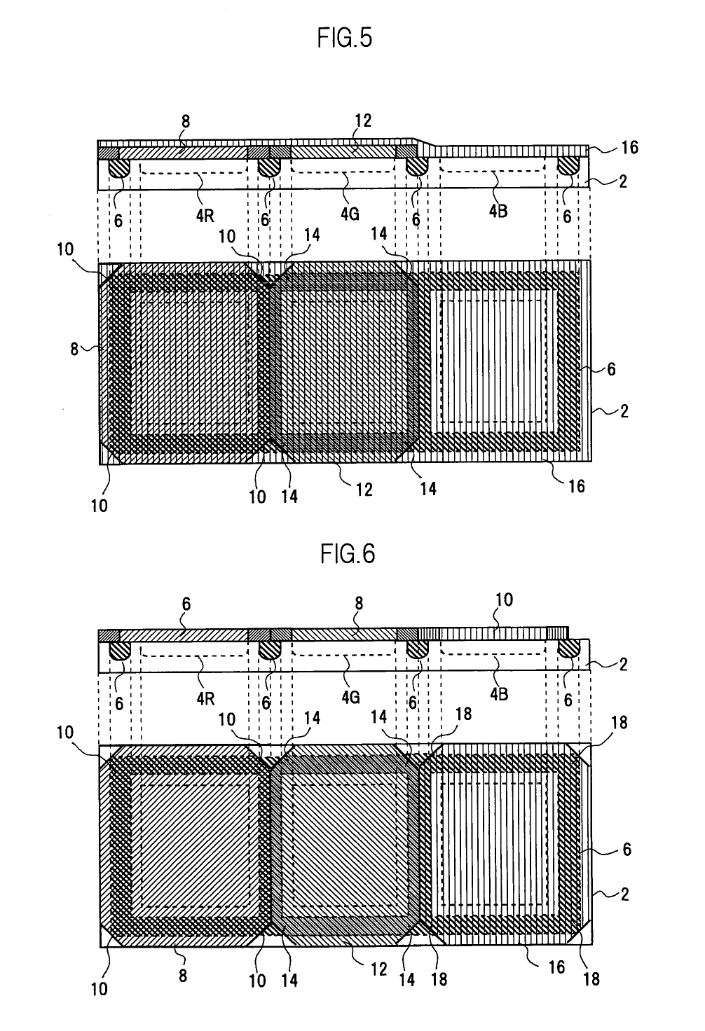

Yet another embodiment of the present invention will be described with reference to FIG. 8. The RGB sensor 1 has a rectangular shape in the embodiment described above; however, the RGB sensor is circular in the present embodiment. When the RGB sensor is circular, light-transmitting films that correspond to each of the RGB colors are formed in an area equally divided into three parts. In the present embodiment, three corners having a fan shape equally divided into three parts are notched and constitute the corner cut portions 10, 14, 18. The light-transmitting film can be formed without coating nonuniformities by the light-transmitting film having corner-cut portions 10, 14, 18 even in such a circular RGB sensor. The corner-cut portions 10, 14, 18 do not have to be provided to the center portion of the circle in a circular RGB sensor.

Although a color filter composed of RGB was described in the embodiment above, the present invention is not limited to such a configuration, and a complimentary color-color filter composed of C (Cyan), M (Magenta), Y (Yellow), and G (Green) may be used.

An embodiment related to a color filter mounted to the RGB sensor 1 was described above, but the present invention can be applied to the manufacture of a color filter for a liquid crystal display device or other device.

The optical element 1 may be a PNP junction wherein an N-well layer is formed by adding an N-type impurity to a P-type semiconductor substrate, and wherein a P-type impurity is added to the N well, or may be an optical element 1 composed of a PIN junction. Furthermore, the optical element 1 may be one in which a P-type impurity is added to an N-type semiconductor substrate. In this case, the area where the P-type impurity was added becomes the light-receiving portion. In other words, the optical element 1 may be one in which the semiconductor substrate 2 receives light and converts the light into an electric signal. An isolation region 6 is formed in the gaps between a plurality of adjacent optical elements 1 in order to electrically isolate the optical elements 1 from each other. For example, the isolation region 6 may be configured by adding a highly concentrated P-type impurity when the optical element 1 is composed of the PN junction described above.

As described above, the light-transmitting film for the color filter according to the present invention has corner-cut portions, whereby a photosensitive resin material can be uniformly spread onto a semiconductor wafer and the occurrence of coating nonuniformities can be prevented when the light-transmitting film of a second color and thereafter is formed.

What is claimed is:

1. A color filter composed of a plurality of kinds of light-transmitting films formed on a substrate and provided with different transmission colors, the plurality of kinds of light-transmitting films being selectively disposed on each of a plurality of optical elements provided to the substrate, wherein:
the light-transmitting films disposed on the optical elements have a planar shape in which corner-cut portions are formed so that right angle portions are removed.

2. The color filter of claim 1, wherein:
an isolation region is formed between adjacent optical elements; and
the corner-cut portions are formed on the isolation region.

3. An optical sensor mounted with the color filter according to claim 1.

4. An optical sensor mounted with the color filter according to claim 2.

5. A method for manufacturing a color filter composed of a plurality of kinds of light-transmitting films formed on a substrate and provided with different transmission colors, the plurality of kinds of light-transmitting films being selectively disposed on each of a plurality of optical elements provided to the substrate, the method for manufacturing a color filter comprising:
a light-transmitting film coating step for coating the light-transmitting film on the entire surface of the substrate; and
a patterning step for patterning the light-transmitting film coated on the substrate in a prescribed planar shape; and
the planar shape having corner-cut portions formed so that right angle portions are removed.

6. The method for manufacturing a color filter of claim 5, further comprising:
a step for forming an isolation region between adjacent optical elements, and
the light-transmitting film being patterned so that the corner-cut portions overlap the isolation region in the patterning step.
